(19) United States
(12) Patent Application Publication
(10) Pub. No.: US 2007/0130211 A1
(43) Pub. Date: Jun. 7, 2007

(54) System and method for downloading contents to mobile terminal

(75) Inventor: Nam Joo Lee, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/634,293

(22) Filed: Dec. 6, 2006

(30) Foreign Application Priority Data
Dec. 7, 2005 (KR) 10-2005-0118649

(51) Int. Cl. G06F 17/00

(52) U.S. Cl. 707/104.1

(57) ABSTRACT

A method for downloading content data to a mobile terminal. The method includes selecting, via the mobile terminal, a desired content data from content data stored on a content server over a mobile communication network, transmitting the selected content data from the content server to a user account server, and downloading the selected content data from the user account server to the mobile terminal over a general communication network.

This application claims the benefit of Korean Patent Application No. 10-2005-0118649, filed on Dec. 7, 2005, which is hereby incorporated by reference in its entirety.

### BACKGROUND OF THE INVENTION

1. Field of the Invention

The present invention relates to a mobile terminal, system and method for downloading contents to a mobile terminal.

2. Discussion of the Related Art

Mobile terminals are widely used an include various functions such as a short messaging service function, a camera function and a downloading function for downloading MP3 files, etc. in addition to a general voice call function. The downloading function is performed by selecting content from a content server and directly downloading the selected content over a mobile communication network.

Further, the related art mobile terminal mainly uses the wireless Internet to download contents. Thus, when several users simultaneously download a large amount of content, the amount of Internet traffic increases. This creates a problem because the wireless Internet network bandwidth is limited. Thus, mobile communication service providers charge a wireless Internet fee to the users based on an amount of contents downloaded.

Therefore, the user has to pay a wireless Internet traffic fee for downloading the contents in addition to a fee for purchasing the contents. This is particularly burdensome for teenagers who frequently want to download contents but have limited financial ability. Furthermore, because the Wireless Internet bandwidth is limited, it is difficult to simultaneously provide the contents to many users.

### SUMMARY OF THE INVENTION

Accordingly, one object of the present invention is to address the above-noted and other problems.

Another object of the present invention is to provide a system and method for downloading multimedia contents without charging the user for both the contents and the downloading function.

Yet another object of the present invention is to provide a method and system for simultaneously providing multimedia contents to many users so as to increase profitability in terms of a multimedia content provider.

To achieve these objects and other advantages and in accordance with the purpose of the invention, as embodied and broadly described herein, the present invention provides in one aspect a method for downloading contents to a mobile terminal. The method includes a) selecting, via the mobile terminal, a desired content data from contents stored on a content server over a mobile communication network, b) transmitting the selected content data from the content server to a user account server, and c) downloading the selected content data from the user account server to the mobile terminal over a general communication network. The present invention also provides a corresponding content downloading system.

In another aspect, the present invention provides a mobile terminal including a display unit configured to display information, an RF communication unit configured to wirelessly communicate with a mobile communication network, and a control unit configured to control the display unit and the input unit. Further, the control units controls the display unit to display a list of contents stored on a content server connected to the mobile terminal via the mobile communication network and a list of user account servers in which a selected content data is to be transmitted to, and downloads the selected content data from the user account server to the mobile terminal over a general communication network.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a block diagram illustrating a mobile terminal according to an embodiment of the present invention;

FIG. 2 is an overview illustrating a content downloading system according to a first embodiment of the present invention;

FIG. 3 is a flowchart illustrating a content downloading method according to the first embodiment of the present invention;

FIGS. 4-1 and 4-2 are overviews illustrating server registration screens of a mobile terminal according to an embodiment of the present invention;

FIGS. 5-1 and 5-2 are overviews illustrating content selection screens the mobile terminal according to an embodiment of the present invention;

FIG. 6 is an overview illustrating a content downloading system according to a second embodiment of the present invention; and

FIG. 7 is a flowchart illustrating a content downloading method according to the second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

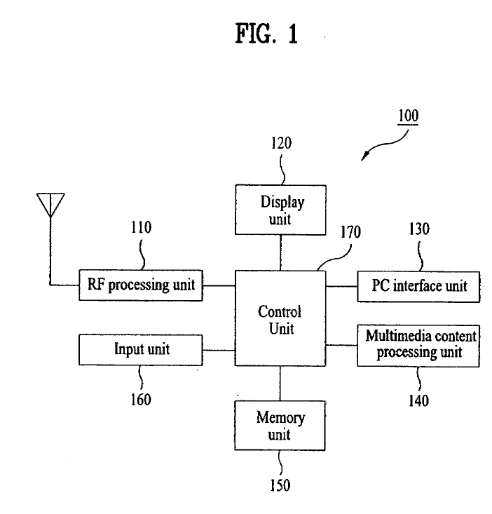

First, a mobile terminal 100 according to an embodiment of the present invention will be described with reference to FIG. 1.

As shown, the mobile terminal 100 includes an RF processing unit 110, a display unit 120, a PC interface unit 130, a multimedia content processing unit 140, a memory unit 150, an input unit 160 and a control unit 170. The RF processing unit 110 allows the mobile terminal 100 to wirelessly communicate with an external device over a communication network. Particularly, the mobile terminal 100 may be connected to a content server (described later) via the RF processing unit 110 over a mobile communication network.

The display unit 120 displays a real-time operation status of the mobile terminal and a variety of menus for performing various functions provided by the mobile terminal 100. The PC interface unit 130 is connected to a personal computer which may be connected to any type of general wired or wireless Internet communication network other than the mobile communication network. Hereinafter, the general network is referred to as a “general communication network.”

Thus, the mobile terminal 100 may communicate with the personal computer via the PC interface 130. The personal computer may be any personalized client system such as a desktop computer, a laptop computer, a handheld computer, etc., and the type of personal computer thereof is not specially limited.

Further, the multimedia content processing unit 140 processes/plays back a variety of multimedia contents such as an MP3 or a moving image. The memory unit 150 stores software for driving various functions on the mobile terminal 100 and a variety of data thereof. In addition, the memory unit 150 may be a detachable flash compact memory. In this instance, a variety of multimedia contents may be stored in the flash compact memory using an external device (for example, a personal computer) and the stored multimedia contents may be played back by inserting the flash compact memory into the mobile terminal 100.

Also, the input unit 160 allows a user to input a variety of commands or information on the mobile terminal 100. The control unit 170 controls the RF processing unit 110, the display unit 120, the PC interface unit 130, the multimedia content processing unit 140, the memory unit 150 and the input unit 160. Particularly, the control unit 170 controls the mobile terminal 100 such that the mobile terminal 100 performs the below described content downloading method according to the present invention.

Hereinafter, the content downloading method according to different embodiments of the present invention will be described.

### First Embodiment

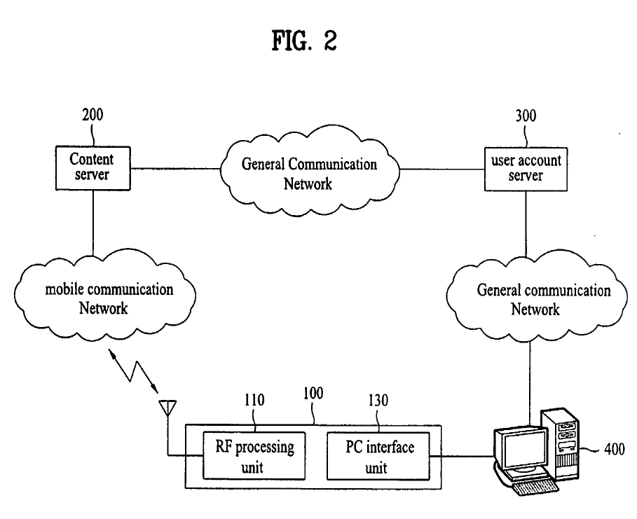

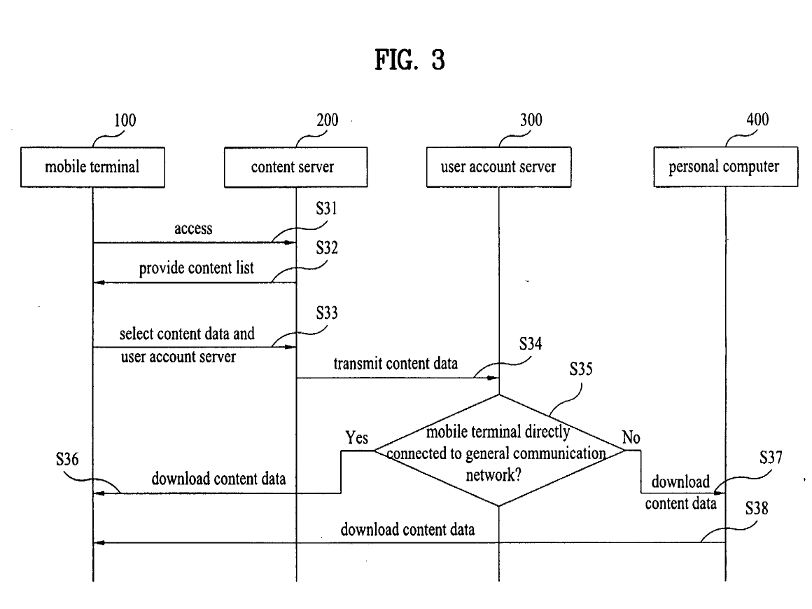

The content downloading method according to the first embodiment of the present invention will now be described with reference to FIGS. 2 and 3. In more detail, FIGS. 2 and 3 are an overview and flowchart illustrating a content downloading system and method, respectively, according to the first embodiment of the present invention. To simplify the below description, the mobile terminal 100 in FIG. 2 only includes the RF processing unit 110 and the PC interface unit 130.

As shown in FIG. 2, the content downloading system includes a content server 220 connected to a user account server 300 over a general communication network. Further, the user account server 300 is connected to the personal computer 400 over the general communication network. The mobile terminal 100 is also connected to the personal computer 400 via the PC interface 130, and is connected to the content server 200 over the mobile communication network using the RF processing unit 110.

The content server 200 is a server that provides content data such as an MP3, a moving image, a music video, etc. The type and the form of the content server 200 are not specifically limited if the mobile terminal can access the content server over the mobile communication network.

Thus, as shown in FIG. 3, to download content data, the mobile terminal 100 first accesses the content server 200 via the RF processing unit 110 (S31). Then, the content server 200 provides a list of content data stored on the content server 200 to the mobile terminal 100 over the mobile communication network (S32). Then, the user of the mobile terminal 100 selects at least one content data from the list of content data.

In addition, the user also selects a user account server 300 indicated where the selected content data is to be transmitted. For example, the user account server 300 can be a server that provides an environment which allows the user to open a new account (for example, a mailing service or a web hard-disk service) and to transmit/receive a file using the account, such as Google or Yahoo.

In addition, the user account server 300 may be selected before the content data is selected. Further, once the user account server 300 is selected, the selected user account server 300 can be saved so the user doesn't have to perform this step again. The process of selecting the user account server 300 will be described later.

Thus, with reference to FIG. 3, when the content data and the user account server is selected, the mobile terminal 100 transmits information on the selected user account server 300 to the content server 200 over the mobile communication network (S33). The information on the user account server 300 is a variety of information used for transmitting the selected content data from the content server 200 to the user account server 300.

For example, the user account server information includes a uniform resource locator (URL) of the user account server 300 and a terminal user ID of the user account server 300. In addition, only the URL and the user ID of the user account server are generally required to transmit a file to the user account server 300. However, a password of the user account server 300 may also be required. In this instance, the password of the user account server 300 is included in the user account server information.

Next, The content server 200 transmits the selected content data to the user account server 300 using the user account server information over the general communication network (S34). The mobile terminal 100 then accesses the user account server 300 over the general communication network and downloads the content data (S35 to S38).

In more detail, if the mobile terminal 100 can be directly connected to the general communication network via the RF processing unit 110, the mobile terminal 100 can directly download the content data from the user account server over the general communication network (S35 and S36).

However, if the mobile terminal cannot be directly connected to the general communication network, the mobile terminal 100 downloads the content data from the user account server 300 via the personal computer 400 (S35, S37 and S38). That is, the personal computer 400 downloads the content data from the user account server 300. Then, the mobile terminal 100 downloads the content data from the personal computer 400.

Further, the personal computer 400 is connected to the user account server 300 over the general communication network. Also, the connection is preferably implemented using the file transfer protocol (FTP) scheme. The mobile terminal 100 may also download the content data from the personal computer 400 using a connection system for connecting the mobile terminal 100 and the personal computer 400 such as the “PC-sync” connection system, or a detachable flash compact memory.

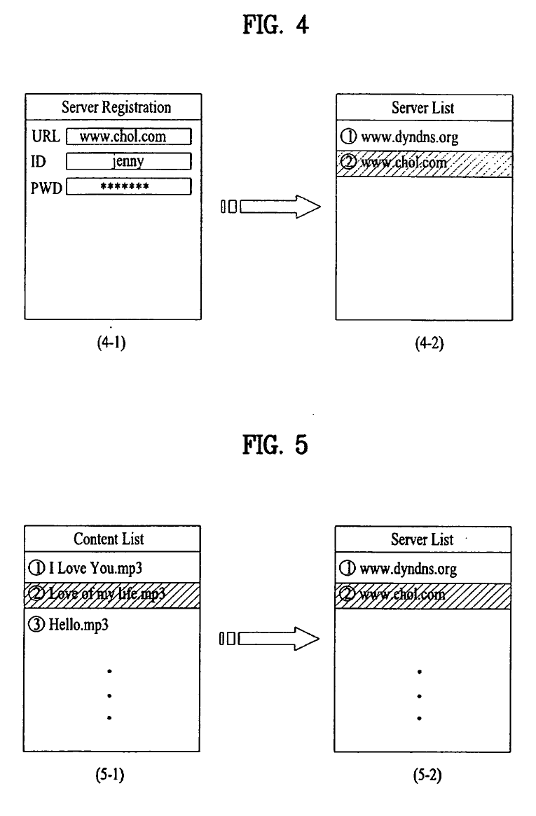

Turning next to FIGS. 4 and 5, which illustrate different screens displayed on the mobile terminal when a user performs the content downloading method according to the present invention.

In more detail, as shown in FIG. 4-1, the user first registers the information on the user account server that will receive the content data. For example, the screen displayed on the mobile terminal 100 requests the user enter the URL, ID and a password related to the user account server. In the example shown in FIG. 4-1, the URL of the user account server is “www.chol.com,” the user's ID is “jenny” and the password is typed in, but hidden (shown as stars “*******”)

Further, as shown in FIG. 4-2, a list of all registered servers may also be displayed to the user via the display unit 120. In this example, the user can see he or she has registered two servers (a server having a URL “www.dyndns.org” and the server having the URL “www.chol.com.” Thus, in this instance, the user may decide to select either one the registered servers.

In addition, FIG. 5 illustrates screens that are displayed to the user when the mobile terminal 100 accesses the content server 200. In more detail, the list of available content data on the content server 200 are first displayed to the user (FIG. 5-1), and then the user is prompted to select a previously registered user account server (FIG. 5-2). Then, the selected content data is transmitted to the selected user account server. The user can then access the user account server using the mobile terminal (if necessary, via the personal computer) and download the selected content data to their mobile terminal.

### Second Embodiment

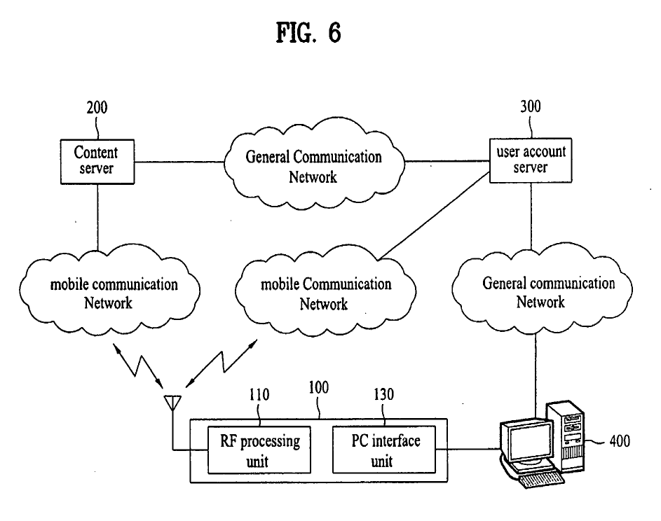

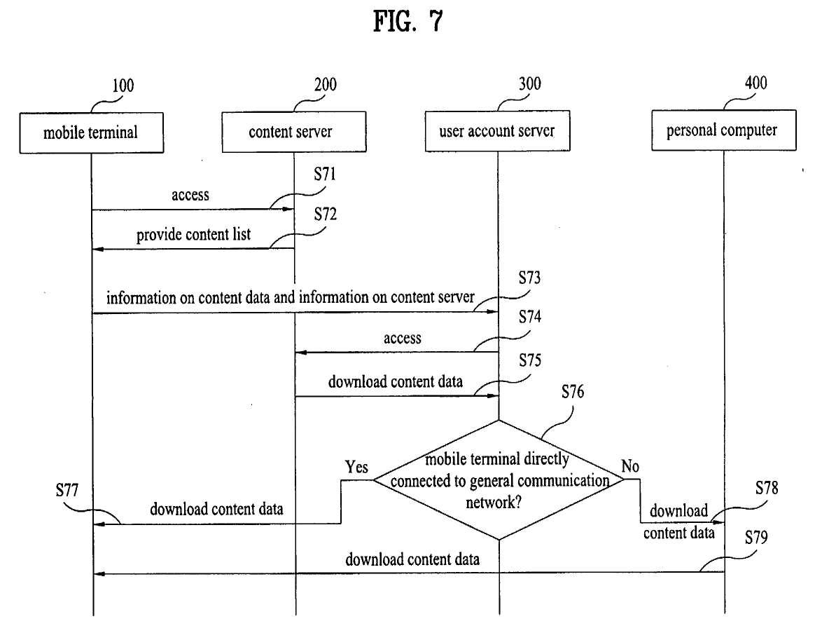

Next, a second embodiment of the present invention will be described with reference to FIGS. 6 and 7. In more detail, FIGS. 6 and 7 are an overview and flowchart illustrating a content downloading system and method, respectively, according to the second embodiment of the present invention.

The system in FIG. 6 is similar to the system in FIG. 2, but the mobile terminal 100 is additionally connected to the user account server 300 via the mobile communication network. Thus, as shown in FIG. 7, the user of the mobile terminal 100 first accesses the content server 200 over the mobile communication network (S71).

Then, the content server 200 provides a list of content data stored on the content server to the mobile terminal 100 over the mobile communication network (S72). The user of the mobile terminal 100 then selects at least one content data from the list of content data over the mobile communication network and transmits information on the selected content data and information on the content server 200 to the user account server 300 over the mobile communication network (S73).

As discussed above, the content server information preferably includes a URL of the content server, a terminal user ID and password of the content server. In addition, the user account server 300 accesses the content server 200 using the content server information over the general communication network and downloads the selected content data (S74 and S75).

Further, the mobile terminal accesses the user account server 300 (if necessary, via the personal computer 400) over the general communication network and downloads the selected content data (S76 to S79). The steps S76 to S79 of the second embodiment are similar to the steps S35 to S38 of the first embodiment and thus the detailed description thereof will be omitted for simplicity purposes.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for downloading content data to a mobile terminal, the method comprising:
a) selecting, via the mobile terminal, a desired content data from content data stored on a content server over a mobile communication network;
b) transmitting the selected content data from the content server to a user account server; and
c) downloading the selected content data from the user account server to the mobile terminal over a general communication network.

2. The method according to claim 1, wherein, in the step c), the mobile terminal downloads the selected content data via a personal computer connected to the user account server.

3. The method according to claim 2, wherein the selected content data is downloaded from the user account server to the personal computer using a file transfer protocol (FTP).

4. The method according to claim 1, wherein the step b) further comprises transmitting information on the user account server to the content server.

5. The method according to claim 4, wherein the information on the user account server includes a uniform resource locator (URL) of the user account server and a mobile terminal user ID of the user account server.

6. The method according to claim 5, wherein, in the step b), the content server transmits the selected content data to the user account server using the information on the user account server.

7. The method according to claim 1, wherein the step b) further comprises transmitting information on the content server and information on the selected content data to the user account server.

8. The method according to claim 7, wherein the information on the content server includes a uniform resource locator (URL) of the content server and a mobile terminal user ID and password of the user account server.

9. The method according to claim 8, wherein, in the step b), the user account server accesses the content server using the information on the content server and downloads the selected content data.

10. A mobile terminal, comprising:
a display unit configured to display information;
an RF communication unit configured to wirelessly communicate with a mobile communication network; and
a control unit configured to control the display unit and the RF communication unit,
wherein the control units controls the display unit to display a list of content data stored on a content server connected to the mobile terminal via the mobile communication network and a list of user account servers in which a selected content data is to be transmitted to, and downloads the selected content data from the user account server to the mobile terminal over a general communication network.

11. The mobile terminal according to claim 10, further comprising:
a personal computer (PC) interface unit configured to interface the mobile terminal with an external PC connected to the user account server over the general communication network,
wherein the control unit downloads the selected content data via the PC connected to the user account server.

12. The mobile terminal according to claim 11, wherein the selected content data is downloaded from the user account server to the personal computer using a file transfer protocol (FTP).

13. The mobile terminal according to claim 10, wherein the RF processing unit transmits information on the user account server to the content server.

14. The mobile terminal according to claim 13, wherein the information on the user account server includes a uniform resource locator (URL) of the user account server and a mobile terminal user ID of the user account server.

15. A content downloading system, comprising:
a content server configured to store a plurality of content data;
a mobile terminal configured to select a desired content data from the plurality of content data stored on the content server over a mobile communication network;
a user account server configured to receive the selected content data from the content server,
wherein the mobile terminal downloads the selected content data from the user account server over a general communication network.

16. The system according to claim 15, further comprising:
a personal computer (PC) connected to the mobile terminal via a PC interface unit on the mobile terminal and connected to the user account server over the general communication network,
wherein the mobile terminal downloads the selected content data via the PC connected to the user account server.

17. The system according to claim 15, wherein the mobile terminal transmits information on the user account server to the content server.

18. The system according to claim 17, wherein the information on the user account server includes a uniform resource locator (URL) of the user account server and a mobile terminal user ID of the user account server.

19. The system according to claim 18, wherein the content server transmits the selected content data to the user account server using the information on the user account server.

20. The system according to claim 15, wherein the mobile terminal transmits information on the content server and information on the selected content data to the user account server.
